(19) United States
(12) Patent Application Publication
(10) Pub. No.: US 2026/0106296 A1
(43) Pub. Date: Apr. 16, 2026

(54) ENERGY STORAGE APPARATUS

(71) Applicant: GS Yuasa International Ltd., Kyoto-shi (JP)

(72) Inventor: Ryohei FUJIKURA, Kyoto-shi (JP)

(21) Appl. No.: 19/422,993

(22) Filed: Dec. 17, 2025

Related U.S. Application Data
(63) Continuation of application No. PCT/JP2024/023184, filed on Jun. 26, 2024.

(30) Foreign Application Priority Data
Jun. 28, 2023 (JP) 2023-105700

(51) Int. Cl. H01M 50/242; H01M 10/613; H01M 10/647; H01M 10/6561; H01M 50/209; H01M 50/262

(52) U.S. Cl. CPC H01M 50/242; H01M 10/613; H01M 10/647; H01M 10/6561; H01M 50/209; H01M 50/262

(57) ABSTRACT

An energy storage apparatus includes a plurality of energy storage devices aligned in a first direction, an end plate located at an end portion of the plurality of energy storage devices in the first direction, and a side plate located at an end portion of the plurality of energy storage devices in a second direction intersecting the first direction. The end plate includes an end plate connecting portion connected to the side plate. The side plate includes a first portion extending in the first direction, a second portion extending from the first portion in the second direction and is connected to the end plate connecting portion, and a third portion extending from the second portion in the first direction along an installation surface of the energy storage apparatus and fixed to the installation surface.

### CROSS REFERENCE TO RELATED APPLICATIONS

This application claims the benefit of priority to Japanese Patent Application No. 2023-105700 filed on Jun. 28, 2023 and is a Continuation Application of PCT Application No. PCT/JP2024/023184 filed on Jun. 26, 2024. The entire contents of each application are hereby incorporated herein by reference.

### BACKGROUND OF THE INVENTION

### 1. Field of the Invention

The present invention relates to energy storage apparatuses.

### 2. Description of the Related Art

An energy storage apparatus of JP2020-30915 A includes a plurality of energy storage devices, a pair of end plates, and a pair of side plates. The plurality of energy storage devices are aligned in one direction, and the end plates are located at both ends of the plurality of energy storage devices. The pair of side plates are located in a direction in which the energy storage devices are aligned such that the energy storage devices are interposed therebetween. Each of both ends of the side plates is joined to the end plate. Thus, the plurality of energy storage devices are fixed by the side plates and the end plates. In the above-described energy storage apparatus, a portion of the end plate is extended to an installation surface, and the extended portion is fixed to the installation surface by a bolt.

### SUMMARY OF THE INVENTION

Incidentally, the energy storage device swells due to repetition of charge and discharge during its use. Consequently, when the energy storage apparatus is used, a force acts on the end plate due to the swelling of the energy storage devices in a direction in which the energy storage devices are aligned. In the energy storage apparatus of JP2020-30915 A, the end plate is fixed to the installation surface. Therefore, when the end plate is deformed due to the swelling of the energy storage device, a force may also act on a portion where the end plate and the installation surface are fixed. This force may present a problem in the installation state, such as the bolt may be damaged.

Example embodiments of the present invention provide energy storage apparatuses each capable of reducing or preventing an occurrence of a problem in an installation state when an energy storage device swells.

An energy storage apparatus according to an example embodiment of the present invention includes a plurality of energy storage devices aligned in a first direction, an end plate located at an end portion of the plurality of energy storage devices in the first direction, and a side plate located at an end portion of the plurality of energy storage devices in a second direction intersecting the first direction, wherein the end plate includes an end plate connecting portion connected to the side plate, and the side plate includes a first portion extending in the first direction, a second portion extending from the first portion in the second direction and is connected to the end plate connecting portion, and a third portion extending from the second portion in the first direction along an installation surface of the energy storage apparatus and fixed to the installation surface.

According to the energy storage apparatuses of the present invention, it is possible to reduce or prevent an occurrence of a problem in an installation state when an energy storage device swells.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view showing an outer appearance of an energy storage apparatus according to an example embodiment of the present invention.

FIG. 2 is a perspective view of an end plate included in the energy storage apparatus of FIG. 1.

FIGS. 3A and 3B are perspective views of a side plate used in the energy storage apparatus of FIG. 1.

FIG. 4 is a front view of the energy storage apparatus of FIG. 1 as seen from a front side.

FIG. 5 is a front view of another example of the energy storage apparatus as seen from the front side.

### DETAILED TDESCRIPTION OF THE EXAMPLE EMBODIMENTS

First, an outline of an energy storage apparatus disclosed in the present specification will be described.
(1) An energy storage apparatus according to an example embodiment of the present invention includes a plurality of energy storage devices aligned in a first direction, an end plate located at an end portion of the plurality of energy storage devices in the first direction, and a side plate located at an end portion of the plurality of energy storage devices in a second direction intersecting the first direction, wherein the end plate includes an end plate connecting portion connected to the side plate, and the side plate includes a first portion extending in the first direction, a second portion extending from the first portion in the second direction and is connected to the end plate connecting portion, and a third portion extending from the second portion in the first direction along an installation surface of the energy storage apparatus and fixed to the installation surface.

According to the energy storage apparatus of an example embodiment of the present invention, not the end plate but the third portion extending from the side plate and the installation surface are fixed by using, for example, a bolt. Consequently, a force received by the end plate is prevented from directly acting on the third portion. Therefore, it is possible to prevent the bolt from being damaged. In other words, it is possible to reduce or prevent an occurrence of a problem in the installation state of the energy storage apparatus when the energy storage device swells.
(2) In the energy storage apparatus described in (1) above, the side plate may include a single sheet of plate material, and the first portion, the second portion, and the third portion may include bent portions of the plate material.

According to the energy storage apparatus described in (2) above, the side plate can be easily manufactured.
(3) In the energy storage apparatus described in (1) or (2) above, the third portion may include an elongated hole configured to receive a fixture to fix the installation surface and the third portion.

According to the energy storage apparatus described in (3) above, when the fixture is inserted into the elongated hole of the third portion to fix the third portion and the installation surface, a position of the fixture can be adjusted within the elongated hole. Therefore, even if a dimensional tolerance of a fixing position of the third portion is increased, the third portion can be fixed to the installation surface by absorbing the tolerance.
(4) In the energy storage apparatus described in any one of (1) to (3) above, the third portion may be provided adjacent to the first portion in the second direction.

Since the energy storage device swells particularly in a vicinity of the center thereof, a vicinity of the center of the end plate particularly receives a force when the energy storage device swells. According to the energy storage apparatus described in (4) above, when the energy storage device swells, if the third portion is provided adjacent to the first portion, that is, at a position distant from the vicinity of the center of the end plate, the third portion is less likely to be affected by the force received by the end plate. By virtue of this feature, it is possible to reduce the influence of the swelling of the energy storage device exerted on the strength of fixing between the third portion and the installation surface.
(5) In the energy storage apparatus described in any one of (1) to (4) above, the end plate may include a raised portion adjacent to the end plate connecting portion, and a thickness of the raised portion may be greater than a thickness of the end plate connecting portion in the first direction.

According to the energy storage apparatus described in (5) above, the end plate increases its thickness in the first direction at a portion that receives the force due to the swelling of the energy storage device, and thus, deformation of the end plate can be reduced or prevented.

In the following, an example embodiment of an energy storage apparatus 100 according to the present invention will be described with reference to the drawings. Numerical values, shapes, materials, elements, positions of arrangement and forms of connection of the elements, and the like, which are indicated in the following example embodiment(s) and modification(s) thereof are merely examples, and are not intended to limit the present invention. Each of the drawings is a schematic view, and dimensions and the like are not necessarily strictly illustrated. In the drawings, same or similar elements are assigned a same reference numeral.

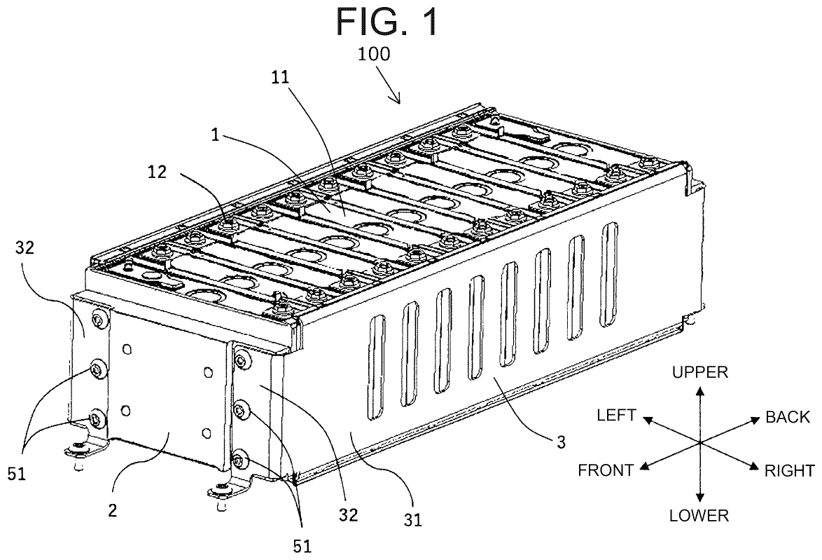

In the following description and the drawings, for convenience of explanation, example embodiments will be described with reference to directions indicated in FIGS. 1 to 4. A direction in which energy storage devices 1 are aligned, or in other words, a direction in which a pair of end plates are opposed to each other, is defined as a front-back direction. A direction in which pair of external terminals of the energy storage device are aligned, or in other words, a direction in which a pair of side plates are opposed to each other, is defined as a left-right direction. A direction in which the external terminal of the energy storage device protrudes, or in other words, a direction intersecting the front-back direction and the left-right direction, is defined as an upper-lower direction. The front-back direction, the left-right direction, and the upper-lower direction mentioned above are directions intersecting each other (orthogonal to each other in the present example embodiment). However, these directions are set for convenience of explanation, and do not limit the present invention. In the following description, the front-back direction will also be referred to as a first direction. The left-right direction will also be referred to as a second direction. The upper-lower direction will also be referred to as a third direction.

Expressions indicating relative directions or postures, such as parallel and orthogonal, include cases where the directions or postures are not parallel or orthogonal in a strict sense. Two directions being orthogonal to each other means not only that the two directions are completely orthogonal to each other, but also that the two directions are substantially orthogonal to each other, so that the two directions crossing each other at an angle deviated from 90 degrees by several degrees is also included in the scope.

FIG. 1 is a perspective view of the energy storage apparatus 100 of the present example embodiment. As illustrated in FIG. 1, the energy storage apparatus 100 includes: a plurality of energy storage devices 1 aligned in the front-back direction (first direction); end plates 2 located at both ends of the plurality of energy storage devices 1 in the front-back direction; and side plates 3 sandwiching the plurality of energy storage devices 1 from both sides in the left-right direction (second direction) which is orthogonal to the front-back direction. That is, the energy storage apparatus 100 includes the end plates 2 located at the both ends of the plurality of energy storage devices 1 in the direction in which the plurality of energy storage devices 1 are aligned, and the side plates 3 sandwiching the plurality of energy storage devices 1 in the direction orthogonal to the direction in which the plurality of energy storage devices 1 are aligned. Apart from the above-described configurations, although the energy storage apparatus 100 includes a spacer located adjacent to the energy storage device 1, an end spacer located adjacent to the end plate, a bus bar connecting the adjacently located energy storage devices 1, and an insulating member located adjacent to the side plate, detailed description thereof will be omitted. Each member will be described below.

Each of the energy storage devices 1 includes a primary battery, a secondary battery, a capacitor, or the like. In the present example embodiment, the energy storage device 1 including a chargeable and dischargeable non-aqueous electrolyte secondary battery will be given as an example. More specifically, each of the energy storage devices 1 is a lithium-ion secondary battery utilizing electron transfer which occurs as transfer of lithium ions takes place.

Each of the energy storage devices 1 includes an electrode body, a case 11 in which the electrode body is accommodated together with an electrolytic solution, and a pair of external terminals 12 at least a part of which protrudes to an outer side of the case 11 in the upper-lower direction. The external terminals 12 are provided as a pair in the left-right direction, which is a width direction, of the energy storage device 1.

The case 11 is formed in a rectangular parallelepiped shape and includes a case main body having an opening on an upper side in the upper-lower direction, and a plate-like lid body which closes the opening of the case main body. The pair of external terminals 12 are respectively located in the vicinity of both ends of the lid body in the left-right direction. The case 11 is formed in a flat rectangular parallelepiped shape having a long length in the left-right direction and the upper-lower direction, and a short length in the front-back direction. The energy storage devices 1 are aligned in the front-back direction such that surfaces thereof in the front-back direction are opposed to each other.

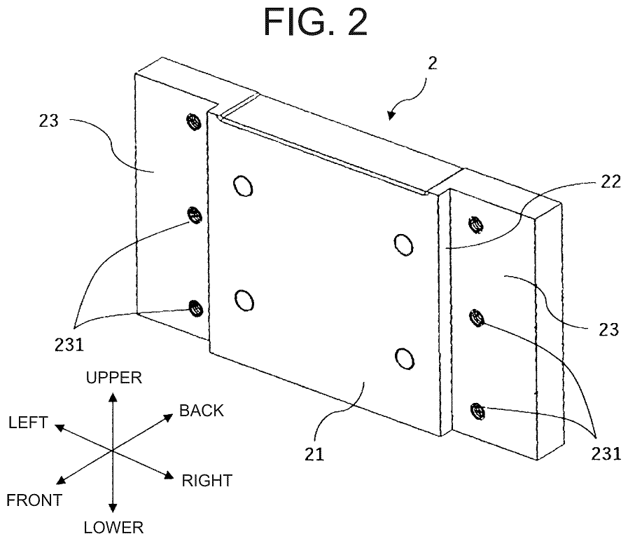

FIG. 2 is a perspective view of the end plate. As illustrated in FIG. 1, the end plates 2 are respectively located on a front side and a back side in the front-back direction of the plurality of energy storage devices 1. However, since the two end plates 2 are the same, the end plate 2, which is in contact with the energy storage device 1 located on the front side, will be described with reference to FIG. 2.

As illustrated in FIG. 2, the end plate 2 is formed in a flat rectangular parallelepiped shape having a short length in the front-back direction. A length of the end plate 2 in the left-right direction is substantially the same as that of the energy storage device 1 in the left-right direction. As illustrated in FIG. 1, the length of the end plate 2 in the upper-lower direction is shorter than that of the energy storage device 1 in the upper-lower direction. A surface of the end plate 2 on the back side in the front-back direction is formed to be flat, and is opposed to the energy storage device 1. The surface of the end plate which is opposed to the energy storage device is formed to be flat.

In the end plate 2, a pair of end plate connecting portions 23 are formed on both sides in the left-right direction. The end plate connecting portion 23 is a part to which the side plate 3 is connected. A plurality of (three in the present example embodiment) screw holes 231 which are aligned in the upper-lower direction are formed in each of the end plate connecting portions 23. The screw hole 231 is also referred to as an end fixing portion fixed to the side plate 3.

A raised portion 21 having a rectangular shape in a front view is formed between the pair of end plate connecting portions 23. In other words, on the front side of the end plate 2 in the front-back direction, the raised portion 21 is formed in an area including a central portion of a surface thereof in the left-right direction. A thickness of the raised portion 21 is formed to be greater than that of the end plate connecting portion 23 in the first direction. The raised portion 21 extends from a lower end to an upper end of the end plate 2 in the upper-lower direction. The end plate connecting portion 23 whose surface is flat is formed on both sides of the raised portion 21 in the left-right direction via a step 22. A second portion 32 of the side plate 3, which will be described later, can be located in a recess formed by the step 22. The end plate 2 may be made of metal. By the presence of the raised portion 21, it is possible to increase the thickness of the end plate in the front-back direction, and the strength of the end plate can be improved.

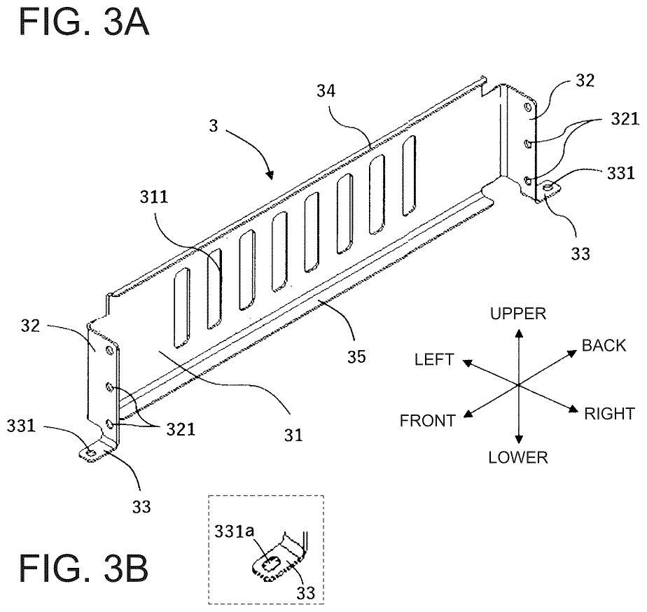

In the present example embodiment, while a pair of side plates 3 are used, the side plates 3 have a bilaterally symmetrical shape. Thus, the side plate 3 which is located on the left side of the energy storage apparatus 100 will be described. FIGS. 3A and 3B are perspective views of the side plate which is located on the left side.

As illustrated in FIGS. 3A and 3B, the side plate 3 is formed by bending a single sheet of metal plate and includes: a first portion 31, which is of a rectangular shape, extending in the front-back direction; the second portion 32, which is of a rectangular shape, joined to each of both ends of the first portion 31 in the front-back direction and extending in the left-right direction; and a third portion 33 which is joined to a lower end of each of the second portions 32 in the upper-lower direction. A fourth part 34 and a fifth part 35 extending to the right side in the left-right direction are respectively joined to the both ends of the first portion 31 in the upper-lower direction.

The first portion 31 is a plate-like portion which is located in the left-right direction of the plurality of energy storage devices 1, and a plurality of through holes 311 extending in the upper-lower direction are formed at predetermined intervals from each other in the front-back direction. Cooling air can be applied to the energy storage devices 1 via the through holes 311.

The second portion 32 is joined to an end portion of the first portion 31 in the front-back direction. That is, the second portion 32 is a plate-like portion which is bent in the left-right direction (second direction) from the end portion of the first portion 31 and extends in the left-right direction. The second portion 32 is connected to the end plate connecting portion 23 of the end plate 2. The second portion 32 is formed in such a shape that conforms to a surface of the end plate connecting portion 23 of the end plate 2, and is fixed such that the second portion 32 is in contact with the end plate connecting portion 23. Therefore, a plurality of (three in the present example embodiment) through holes 321 which are aligned in the upper-lower direction are formed in an end portion of the second portion 32 in the left-right direction. These through holes 321 are formed at positions corresponding to the screw holes 231 of the end plate 2. The through hole 321 is also referred to as a first side fixing portion fixed to the end plate 2. The through hole (first side fixing portion) 321 of the side plate 3 and the screw hole (end fixing portion) 231 of the end plate 2 are fixed by a bolt.

A length of the second portion 32 in the upper-lower direction is shorter than a length of the first portion 31 in the upper-lower direction. The length of the second portion 32 in the upper-lower direction is substantially the same as the length of the end plate 2 in the upper-lower direction. The lower end of the second portion 32 in the upper-lower direction is located at substantially the same height as the lower end of the first portion 31 in the upper-lower direction.

The third portion 33 is a plate-like portion which is bent in a direction along the front-back direction from the lower end of the second portion 32 in the upper-lower direction and extends in the front-back direction (first direction). The third portion 33 extends along an installation surface 8 on which the energy storage apparatus 100 is to be installed. As indicated in illustration FIG. 3A, a circular through hole 331 is formed in the third portion 33, and a bolt (a fixing member) is inserted into the through hole 331. The through hole 331 is also referred to as a second side fixing portion fixed to the installation surface 8. The installation surface 8 is a surface on which the energy storage apparatus 100 is set and fixed. Examples of the installation surface 8 include a floor surface of an energy storage apparatus case which accommodates therein the energy storage apparatus 100, a shelf board of a rack on which the energy storage apparatus is placed, and the like.

The fourth portion 34 is a plate-like portion which extends along an upper end of the first portion 31 in the upper-lower direction, is bent at a right angle from the upper end, and extends in the left-right direction. The fourth portion 34 is formed to have a short length in the left-right direction, and comes into contact with the respective upper surfaces of the plurality of energy storage devices 1 in the upper-lower direction. The fifth portion 35 is a plate-like portion which extends along the lower end of the first portion 31 in the upper-lower direction, is bent at a right angle from the lower end, and extends in the left-right direction. The fifth portion 35 is formed to have a short length in the left-right direction, and comes into contact with the respective lower surfaces of the plurality of energy storage devices 1 in the upper-lower direction.

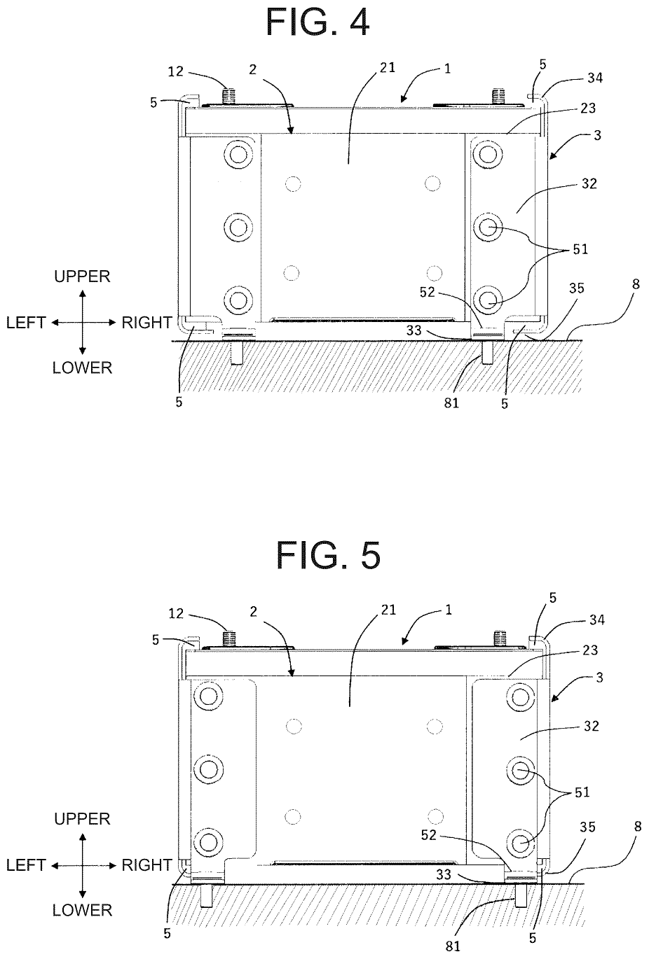

Next, a method of assembling the energy storage apparatus 100 configured as described above will be described. First, the plurality of energy storage devices 1 are located in the front-back direction. Next, the end plates 2 are respectively located at the both ends of the plurality of energy storage devices 1 in the front-back direction. After that, the side plates 3 are respectively attached to the both ends of the plurality of energy storage devices 1 in the left-right direction. Specifically, the plurality of energy storage devices 1 are located between the fourth portion 34 and the fifth portion 35 of each of the side plates 3. An insulating member 5 is located between the fourth portion 34 and the plurality of energy storage devices 1, and between the fifth portion 35 and the plurality of energy storage devices 1. As described above, the plurality of energy storage devices 1 are supported by the side plates 3 from the upper side and the lower side in the upper-lower direction. In this connection, the second portion 32 of each of the side plates 3 is stacked on the end plate connecting portion 23 of the end plate 2 to be located thereon. Next, as illustrated in FIG. 4, a bolt 51 is inserted into each of the through holes 321 of the second portion 32, and is screwed into each of the screw holes 231 of the end plate 2. In this way, the side plate 3 is fixed to the end plate 2. As a result, the plurality of energy storage devices 1 are fixed integrally by the end plates 2 and the side plates 3. The energy storage apparatus 100 is formed by connecting the adjacently located energy storage devices 1 with a bus bar.

As illustrated in FIG. 4, the third portion 33 of the side plate 3 is fixed to a screw hole 81 formed in the installation surface 8 on which the energy storage apparatus 100 is installed. Specifically, a bolt 52 is inserted into the through hole (second side fixing portion) 331 of the third portion 33, and is screwed into the screw hole 81 of the installation surface 8. The bolt 52 is an example of a fixing member. In this way, the energy storage apparatus 100 is fixed to the installation surface 8.

The energy storage apparatus 100 configured as described above exhibits the following effects.
(1) When the energy storage device 1 swells, the end plate 2 receives a force. If the end plate 2 and the installation surface 8 are fixed by a bolt or the like, a force due to the swelling of the energy storage device 1 directly acts on the bolt. Thus, the bolt may be damaged. In contrast, according to the present example embodiment, not the end plate 2 but the third portion 33 formed in the side plate 3 and the installation surface 8 are fixed by the bolt 52. Consequently, the force due to the swelling of the energy storage device 1 is prevented from directly acting on the third portion 33. Therefore, it is possible to prevent the bolt 52 for fixing the third portion 33 and the installation surface 8 from being damaged. In other words, it is possible to reduce or prevent an occurrence of a problem in the installation state of the energy storage apparatus 100.
(2) The side plate 3 is formed of a single sheet of plate material, and the first portion 31, the second portion 32, and the third portion 33 are formed by bending such a plate material. Since the side plate 3 can be formed by bending the single sheet of plate material, the side plate 3 can be easily manufactured.
(3) The thickness of the raised portion 21 of the end plate 2 in the front-back direction (first direction) is greater than that of the end plate connecting portion 23. By virtue of this feature, the end plate 2 has an increased thickness in the front-back direction at a part which receives the force due to the swelling of the energy storage device, and thus, deformation of the end plate 2 can be reduced or prevented. The third portion 33 is less likely to be affected by the swelling of the energy storage device. Therefore, it is possible to reduce the risk of the force due to the swelling of the energy storage device 1 affecting the bolt 52 for fixing the energy storage apparatus 100 onto the installation surface 8. Since the second portion 32 of the side plate 3 is fixed by being stacked on the end plate 2, the second portion 32 also contributes to the suppression of the deformation of the end plate 2.
(4) The energy storage device 1 swells in the front-back direction. The second portion 32 of the side plate 3 is fixed to the end plate 2 in the front-back direction. Since the second portion 32 is fixed by being stacked on the end plate connecting portion 23 of the end plate 2, the second portion 32 is less likely to be affected by the swelling of the energy storage device.

Although example embodiments of the present invention have been described above, the present invention is not limited to this example embodiments, and various changes can be made to the example embodiments on condition that the changes do not depart from the spirit of the present invention. The following modifications can be combined with the above-described example embodiments, and the modifications can also be combined with each other as appropriate.
(1) It is sufficient if the side plate 3 includes at least the first portion 31 extending in the front-back direction, the second portion 32 fixed to the end plate 2, and the third portion 33 fixed to the installation surface 8. The shape of the respective portions is not particularly limited. Therefore, the fourth portion 34 and the fifth portion 35 are not necessarily required, and may be provided if necessary.
(2) In the above-described example embodiments, the side plate 3 is formed by bending a single sheet of plate material. However, the side plate 3 may alternatively be formed by combining a plurality of members. For combining (connecting) the plurality of plate materials, welding or riveting may be used apart from screwing.
(3) The shape of the through hole 331 formed in the third portion 33 of the side plate 3 is not particularly limited, and may be an elongated hole extending in the front-back direction (first direction) as indicated in illustration FIG. 3B. By this shape, the position of the bolt 52 can be moved within an elongated hole 331a. Since the plurality of energy storage devices 1 are arrayed in the front-back direction, the energy storage apparatus 100 is long in the front-back direction. A dimensional tolerance of a position of the energy storage apparatus 100 to be fixed to the installation surface is increased. Therefore, if the through hole is an elongated hole, the screw hole 81 of the installation surface 8 and the elongated hole 331a can be fixed by the bolt 52 by absorbing the tolerance.
(4) A method of fixing the third portion 33 to the installation surface 8 is not particularly limited, and various modes using means other than the bolt 52 are possible. That is, it is sufficient if the third portion 33 and the installation surface 8 can be fixed. Examples of the fixing method not using a bolt include welding and riveting.
(5) In the above-described example embodiments, the third portion 33 is provided at a position distant from the first portion 31 in the left-right direction. (The third portion 33 is provided at a position closer to a center of the end plate 2 in the left-right direction and near the raised portion 21.) However, the position of the third portion 33 is not particularly limited. As illustrated in FIG. 5, the third portion 33 can be provided near the first portion 31 in the second portion 32. This structure brings about the following advantages.

If the energy storage device 1 swells, it is possible that a vicinity of the center of the end plate 2 may be particularly deformed. However, if the third portion 33 is provided at a position near the first portion 31, in other words, at a position distant in the left-right direction from the central portion of the end plate 2, the third portion 33 is less likely to be affected by the deformation of the end plate 2. Thus, it is possible to reduce the influence that the deformation of the end plate 2 exerts on the strength of fixing between the third portion 33 and the installation surface 8.
(6) The shape of the end plate 2 is not particularly limited as long as the end plate 2 can be located to be directly or indirectly in contact with the energy storage devices 1 at the both ends in the front-back direction, and can fix the second portion 32 of the side plate 3. In the above-described example embodiments, the raised portion 21 is provided at the center of the end plate 2. However, the shape of a front surface of the end plate 2 is not particularly limited as long as the second portion 32 of the side plate 3 can be fixed thereto as described above. That is, a mode in which no raised portion 21 is provided is also possible. The thickness of the end plate 2 is also not particularly limited, and the end plate 2 may be plate-shaped likewise the side plate 3.
(7) The configuration of the energy storage device 1 is not particularly limited, and a configuration of a known energy storage device can be adopted. For example, the energy storage device 1 may have a long cylindrical shape instead of a rectangular parallelepiped shape. The energy storage device 1 may have a pouch shape.
(8) In the above-described example embodiments, the end plate 2 is a thick metal member having no hollow portion except for the through hole. However, the end plate 2 is not limited this configuration. The end plate may be entirely or partially shaped like a lattice. Since empty spaces are formed within the lattice, the weight of the end plate can be reduced. In this connection, the end plate is also provided with rigidity by virtue of the lattice shape. The end plate 2 may be a metal member having unevenness.

Example embodiments of the present invention can be applied to an energy storage apparatus 100 provided with an energy storage device such as a lithium-ion secondary battery.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
a plurality of energy storage devices aligned in a first direction;
an end plate located at an end portion of the plurality of energy storage devices in the first direction; and
a side plate located at an end portion of the plurality of energy storage devices in a second direction intersecting the first direction; wherein
the end plate includes an end plate connecting portion connected to the side plate; and
the side plate includes:
a first portion extending in the first direction;
a second portion extending from the first portion in the second direction and is connected to the end plate connecting portion; and
a third portion extending from the second portion in the first direction along an installation surface of the energy storage apparatus and fixed to the installation surface.

2. The energy storage apparatus according to claim 1, wherein the side plate includes a single sheet of plate material, and the first portion, the second portion, and the third portion include bent portions of the plate material.

3. The energy storage apparatus according to claim 1, wherein the third portion includes an elongated hole configured to receive a fixture to fix the installation surface and the third portion.

4. The energy storage apparatus according to claim 1, wherein the third portion is provided adjacent to the first portion in the second direction.

5. The energy storage apparatus according to claim 1, wherein the end plate includes a raised portion adjacent to the end plate connecting portion, and a thickness of the raised portion is greater than a thickness of the end plate connecting portion in the first direction.
